(19) United States
(12) Patent Application Publication
(10) Pub. No.: US 2024/0401883 A1
(43) Pub. Date: Dec. 5, 2024

(54) EXHAUST STACK FOR GLASS MELTER

(71) Applicant: Owens-Brockway Glass Container Inc., Perrysburg, OH (US)

(72) Inventors: Shane Rashley, Bowling Green, OH (US); Jorge Hernan Luna Gutierrez, Lima (PE)

(21) Appl. No.: 18/325,207

(22) Filed: May 30, 2023

(51) Int. Cl. F27D 17/00; C03B 5/193; C03B 5/235; F23J 15/06

(52) U.S. Cl. CPC F27D 17/002; C03B 5/193; C03B 5/2356; F23J 15/06

(57) ABSTRACT

An exhaust stack for a submerged combustion melter includes a lower flue, an upper flue, an expansion joint between the lower and upper flues, and a hood. The lower flue is coupled to a tank of a submerged combustion melter and the upper flue and the lower flue are compliantly coupled together by the expansion joint. The hood is coupled to the upper flue and includes a circumferential shell that defines one or more diluent inlets for introducing a diluent directly into an exhaust material flowing through the exhaust stack. The exhaust material may also additionally be cooled in the lower flue, the upper flue, or both, prior to the exhaust material flowing through the hood. A submerged combustion melting system that includes a submerged combustion melter and the exhaust stack, as well as a method of cooling an exhaust material that exits a submerged combustion melter, are also disclosed.

### TECHNICAL FIELD

This patent application discloses innovations related to submerged combustion melting systems and, more particularly, to an exhaust stack for a submerged combustion melter.

### BACKGROUND

A submerged combustion melter includes a tank to hold a glass melt and submerged combustion burners mounted in a floor or sidewall of the tank to discharge combustion products directly into the glass melt. The tank defines a batch inlet through which batch feed material is introduced into the tank, a molten glass outlet from which molten glass is pulled from the tank, and an exhaust outlet that communicates with a head space above the glass melt. An exhaust material generated during operation of the melter exits the tank through the exhaust outlet and is typically directed through an exhaust structure of some kind. However, when operating the submerged combustion melter, the direct firing of combustion products into the glass melt causes severe turbulence within the melt, and the resultant splashing and constant disturbance of the glass melt may propel molten glass spatter through the exhaust outlet and into the exhaust structure. The molten glass that is thrown into the exhaust structure may solidify and, over time, accumulate onto an interior surface of the ductwork or other components of the exhaust structure. The accumulation of solidified glass within the exhaust structure may lead to operational challenges such as restricting the volume through which the exhaust material can flow, and possibly even clogging of the exhaust structure, which can trigger unwanted internal pressure variances within the melter. Glass that accumulates within the exhaust structure may also capture fine particulates and exhaust condensate and, thus, further increase exhaust-related build-up.

### SUMMARY OF THE DISCLOSURE

A submerged combustion melting system according to one embodiment of the present disclosure includes a submerged combustion melter and an exhaust stack. The submerged combustion melter includes a tank, which defines an exhaust outlet, and one or more submerged burners mounted to the tank. The exhaust stack is connected to the tank of the melter and includes a lower flue, an upper flue, an expansion joint, and a hood. The lower flue is coupled to the tank and extends upwardly away from the tank. The lower flue includes a circumferential shell that defines an exhaust flow passage and fluidly communicates with the exhaust outlet of the tank. The upper flue extends upwardly away from the lower flue and includes a circumferential shell that defines an exhaust flow passage. The upper flue fluidly communicates with the lower flue. The expansion joint is disposed between the lower flue and the upper flue and compliantly couples the lower flue and the upper flue together. The hood is coupled to the upper flue and extends upwardly away from the upper flue. The hood fluidly communicates with the upper flue and includes a circumferential shell that defines an exhaust flow passage and has an interior refractory liner. The circumferential shell of the hood also defines one or more dilution inlets and a hood outlet.

Additionally, an exhaust stack for a submerged combustion melter according to one embodiment of the present disclosure includes a lower flue, an upper flue, an expansion joint, and a hood. The lower flue includes a circumferential shell having an interior surface that defines an exhaust flow passage of the lower flue. The circumferential shell of the lower flue also defines an internal cooling passage configured to circulate a coolant through the circumferential shell of the lower flue. The upper flue includes a circumferential shell having an interior surface that defines and exhaust flow passage of the upper flue. The circumferential shell of the upper flue also defines an internal cooling passage configured to circulate a coolant through the circumferential shell of the upper flue. The expansion joint is disposed between the lower flue and the upper flue and compliantly couples the lower flue and the upper flue together. The hood is coupled to the upper flue and includes a circumferential shell. The circumferential shell of the hood has an interior refractory liner that defines an exhaust flow passage of the hood. Moreover, the circumferential shell of the hood defines one or more dilution inlets, and each of the one or more dilution inlets extends through the circumferential shell of the hood to the exhaust flow passage of the hood.

Still further, a method of cooling an exhaust material exiting a submerged combustion melter according to one embodiment of the present disclosure includes several steps. One step of the method involves discharging combustion products from one or more submerged combustion burners directly into a glass melt contained within an interior of a tank of a submerged combustion melter to heat and agitate the glass melt. Another step of the method involves directing an exhaust material generated within the interior of the tank through an exhaust outlet of the tank and flowing the exhaust material through an exhaust stack that is connected to the tank of the submerged combustion melter. The exhaust stack includes a lower flue coupled to the tank and in fluid communication with the exhaust outlet, an upper flue in fluid communication with the lower flue, and a hood in fluid communication with the upper flue. Another step of the method involves cooling the exhaust material in the lower flue with a coolant that circulates within an internal cooling passage of the lower flue or by spraying a cooling fluid directly into the exhaust material as the exhaust material flows through the lower flue. Still another step of the method involves cooling the exhaust material in the upper flue with a coolant that circulates within an internal cooling passage of the upper flue or by spraying a cooling fluid directly into the exhaust material as the exhaust material flows through the upper flue. Yet another step of the method involves cooling the exhaust material in the hood by directly mixing a diluent into the exhaust material as the exhaust material flows through the hood. Another step of the method involves flowing the exhaust material out of the hood, through a hood outlet, and downstream of the exhaust stack.

### BRIEF DESCRIPTION OF THE DRAWINGS

FIG. 1 is a perspective view of a submerged combustion melting system including an exhaust stack in accordance with an illustrative embodiment of the present disclosure;

FIG. 2 is a rear view of the exhaust stack depicted in FIG. 1;

FIG. 3 is a side view of the exhaust stack depicted in FIG. 1;

FIG. 4 is a cross-sectional view of the exhaust stack depicted in FIG. 1, taken along section line 4-4 in FIG. 3;

FIG. 5 is a perspective view of the lower flue, the upper flue, and the expansion joint of the exhaust stack depicted in FIG. 1;

FIG. 6 is a perspective view of the lower flue of the exhaust stack depicted in FIG. 1;

FIG. 7 is a perspective view of the upper flue of the exhaust stack depicted in FIG. 1;

FIG. 8 is an enlarged fragmentary cross-sectional view of the expansion joint of the exhaust stack depicted in FIG. 1, taken along section line 8-8 in FIG. 5;

FIG. 9 is a cross-sectional view of the lower flue of the exhaust stack depicted in FIG. 1, taken along section line 9-9 in FIG. 6;

FIG. 10 is a cross-section view of the upper flue of the exhaust stack depicted in FIG. 1, taken along section line 10-10 in FIG. 7;

FIG. 11 is a side view of a hood of the exhaust stack depicted in FIG. 1;

FIG. 12 is a cross-sectional view of the hood of the exhaust stack depicted in FIG. 1, taken along section line 12-12 in FIG. 11; and

FIG. 13 is a top view of the hood of the exhaust stack depicted in FIG. 1.

### DETAILED DESCRIPTION

Submerged combustion melting of glass involves vigorously agitating the glass melt with combustion products discharged directly into the melt from submerged burners. The agitation of the melt mixes the various components of a batch feed material into the melt and promotes efficient heat transfer, each of which helps reduce the necessary residence time of the glass, therefore allowing the glass melter to be smaller in size and glass capacity compared to a conventional glass furnace. However, the turbulence created within the glass melt causes the melt to slosh and splash, which can lead to molten glass spatter being thrown up to and out of an exhaust outlet. The present disclosure describes an exhaust stack that accommodates the disturbed nature of a submerged combustion glass melt. Notably, the disclosed exhaust stack is designed to minimize the adherence and accumulation of glass within the stack-particularly the initial portion of the stack located closest to the melter-so that any molten glass that splashes into the exhaust stack is more likely to fall back into the melter, and to also inhibit exhaust material condensate from accumulating within the stack. This targeted approach to the design and operation of the exhaust stack helps the stack remain clear from unacceptable obstruction, which, in turn, promotes more consistent and reliable operation of the melter.

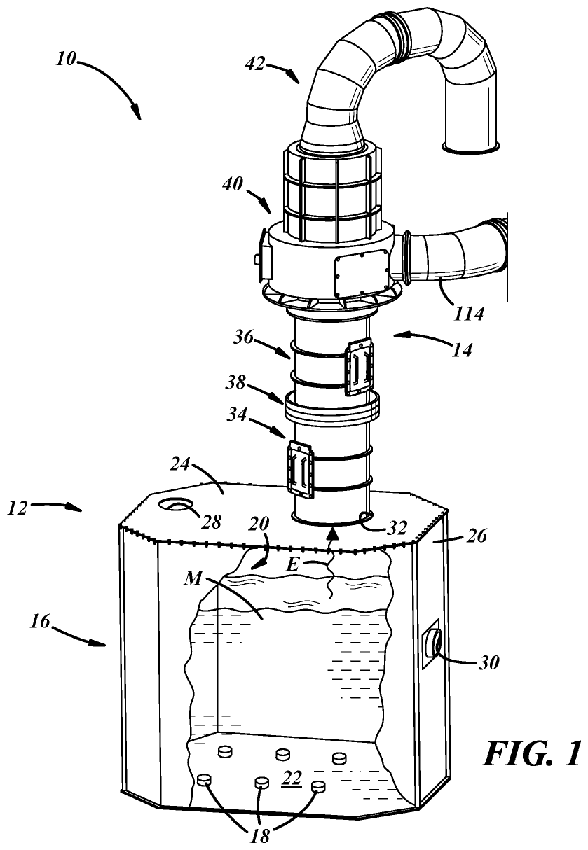

Referring now to FIG. 1, a submerged combustion (SC) melting system 10 is shown that includes a SC melter 12 and an exhaust stack 14 that receives and directs an exhaust material E away from the melter 12. The melter 12 may be operated to melt a batch feed material within a glass melt M to produce molten glass. When the melter 12 is used to produce glass, the exhaust material E is generated within the melter 12 and is typically composed of a combination of the combustion products that are discharged directly into the glass melt M, the volatilization of certain species out of the glass melt M, and possible carryover of the batch feed material. In that regard, the exhaust material E might ordinarily include any or all of the following: CO₂, H₂O₍ᵥ₎, N₂, O₂, NO_{X}, SO_{X}, uncombusted fuel (e.g., CH₄, C₃H₆, H₂, etc.), and/or batch feed material particulates. As described in more detail below, the exhaust material E generated within the melter 12 flows into and through the exhaust stack 14 so that the exhaust material E may eventually undergo downstream treatment, abatement, recycling, release, or other processing.

The melter 12 includes a tank 16 and one or more submerged combustion burners 18. The tank defines an interior 20 in which the glass melt M is contained and has a floor 22, a roof 24, and a perimeter wall 26 extending between the floor 22 and the roof 24. The tank 16 may be configured to have any suitable cross-sectional shape when viewed normal to a plane that intersects the perimeter wall 26 and lies parallel to the floor 22 as well as when viewed normal to a plane that intersects the floor 22 and the roof 24 and lies perpendicular to the floor 22. The one or more submerged combustion burners 18 are submerged by the glass melt M. The burners 18 are typically mounted in the floor 22 of the tank 16—but may in some instances be mounted in the perimeter wall 26 in addition to or in lieu of being mounted in the floor 22—and are arranged to discharge combustion products directly into the glass melt M to heat and agitate the melt M. The combustion products discharged from the submerged burner(s) 18 include the products of a combustion reaction between a fuel and an oxidant and, as such, may primarily include CO₂ (if the fuel is a hydrocarbon) and H₂O₍ᵥ₎ plus any uncombusted fuel and oxidant. The fuel may include methane, propane, or hydrogen, and the oxidant may include oxygen delivered as commercially pure oxygen or as a component of air, although other materials may be used as the fuel and the oxidant. The submerged burner(s) 18 extend through the tank 16 and are connected to pipes, hoses, or other conduits that supply the burner(s) 18 with the fuel, the oxidant, and any other fluids such as, for instance, a burner coolant.

The tank 16 defines at least three openings of the melter 12 that provide access to the interior 20: a batch inlet 28, a molten glass outlet 30, and an exhaust outlet 32. The batch inlet 28 is the opening through which the batch feed material is introduced into the interior 20 of the tank 16. The batch feed material is melted within the glass melt M to produce molten glass and may be formulated to produce, for example, soda-lime-silica glass when melted. To that end, the batch feed material may include virgin raw materials such as sand, soda ash, limestone, and may also include recycled or previously-formed glass known in the industry as “cullet.” The batch inlet 28 may be defined anywhere in the tank 16, although typically the inlet 28 is defined in the roof 24 or the perimeter wall 26 (at a submerged or non-submerged location). The molten glass outlet 30 is the opening through which molten glass is pulled from the glass melt M and withdrawn from the tank 16. The molten glass outlet 30 is typically defined in the perimeter wall 26 of the tank 16 at a location that is submerged by the glass melt M. The exhaust outlet 32 is the opening through which the exhaust material E escapes out of the tank 16 and into the exhaust stack 14. The exhaust outlet 32 fluidly communicates with a head space of the interior 20 of the tank 16—that is, the open space of the interior 20 above the glass melt M—and, for that reason as well as others mentioned below, is preferably defined in the roof 24 of the tank 16.

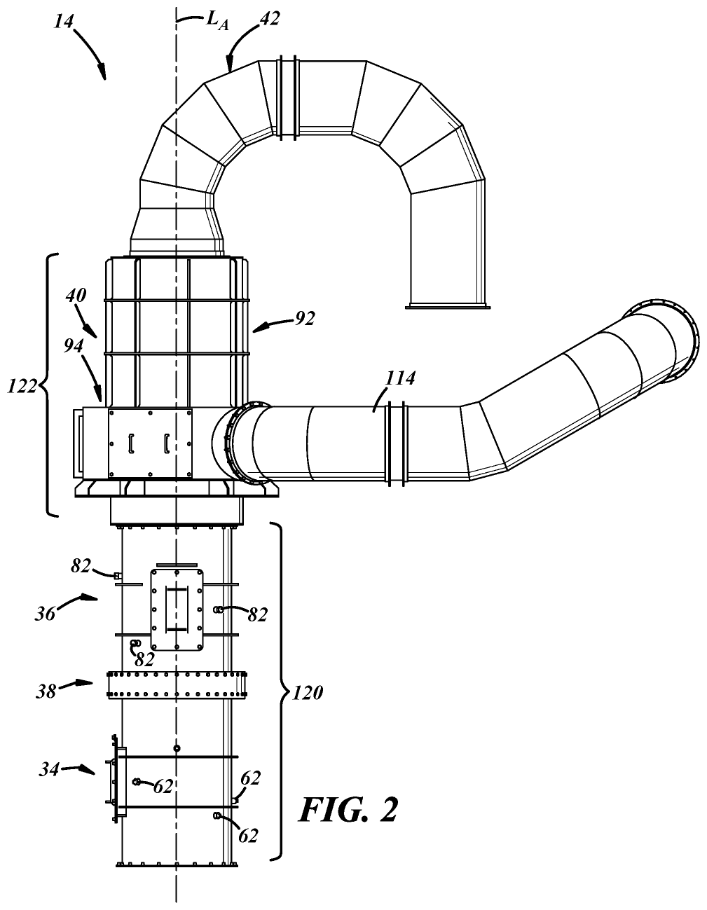

The exhaust stack 14 is connected to the melter 12 and, more specifically, to the tank 16 of the melter 12. The exhaust stack 14 fluidly communicates with the interior 20 of the tank 16 through the exhaust outlet 32. In this way, the exhaust material E generated in the melter 12 is directed into and flows through the exhaust stack 14 in a contained manner and is carried away from the melter 12. The exhaust stack 14 includes a lower flue 34, an upper flue 36, an expansion joint 38, a hood 40, and an exhaust outlet conduit 42. The lower flue 34 is coupled to the tank 16 and fluidly communicates with the exhaust outlet 32 and the interior 20 of the tank 16. And, as shown in FIG. 2, the lower flue 32 extends upwardly away from the roof 24 of the tank 16, preferably along a longitudinal axis L_{A} (FIG. 2) that extends centrally through the exhaust outlet 32. The upper flue 36 is coupled to and fluidly communicates with the lower flue 32, and, as shown, extends upwardly away from the lower flue 34, also preferably along the longitudinal axis L_{A} similarly to the lower flue 34. The expansion joint 38 is disposed between and compliantly couples the lower flue 34 and the upper flue 36 together. The hood 40 is coupled to and fluidly communicates with the upper flue 36 and the exhaust outlet conduit 42 is coupled to and fluidly communicates with the hood 40. The hood 40 extends upwardly and away from the upper flue 36 and may, as shown, extend along the same longitudinal axis L_{A} as the lower and upper flues 34, 36. The exhaust outlet conduit 42 preferably delivers the exhaust material E from the hood 40 to additional downstream treatment, recycling, or abatement unit operations, for example, or it may direct the exhaust material E elsewhere.

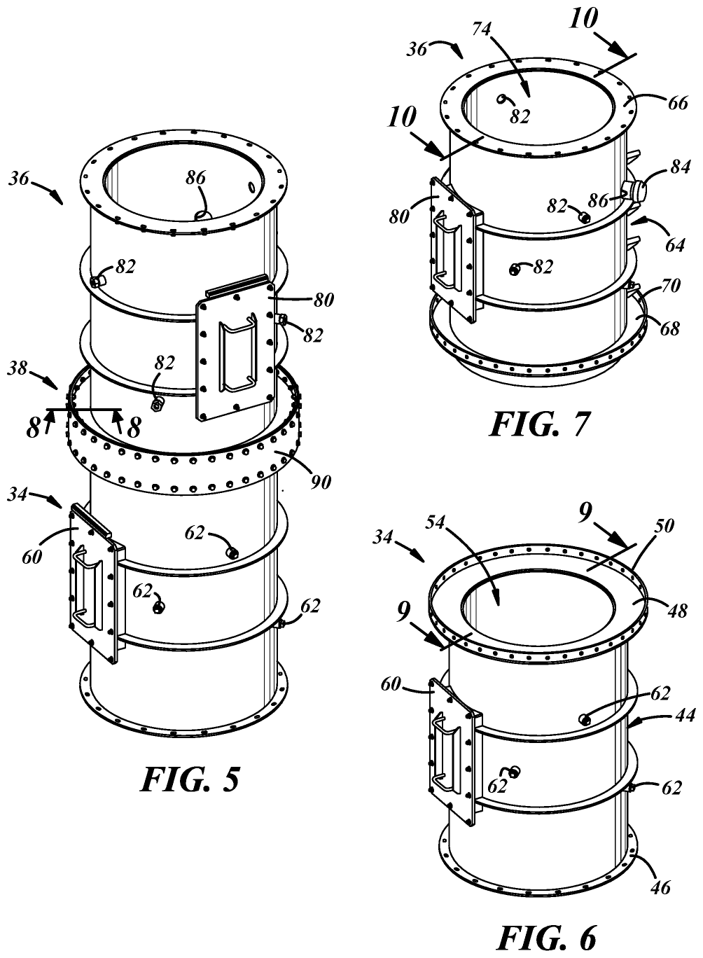

With reference now to FIGS. 6 and 9, the lower flue 34 includes a circumferential shell 44, a lower radial flange 46, and an upper radial flange 48 that has an axially-extending peripheral lip 50 that projects upwardly away from the lower radial flange 46. The circumferential shell 44 has an interior surface 52 that defines an exhaust flow passage 54 of the lower flue 34. The circumferential shell 44 may be cylindrical in shape, and therefore circular in cross-section, although other configurations are certainly possible including those that provide the shell 44 with other cross-sectional shapes including, for example, ovular, octagonal, hexagonal, and rectangular. The term “circumferential” as used herein to describe portions of the exhaust stack 14 is thus not limited to a cylinder having a circular cross-section but, rather, is intended to encompass any closed, hollow cross-sectional shape, unless specifically stated otherwise. The lower radial flange 46 and the upper radial flange 48 each extend radially outwardly from the circumferential shell 44 and are spaced axially apart along, and are disposed proximate to opposed ends of, the circumferential shell 44. The lower radial flange 46 is connected, typically with fasteners (as shown) or metallurgical joints, to the roof 24 of the tank 16 of the melter 12 (FIG. 1), and the upper radial flange 48 is connected, again typically with fasteners (as shown) or metallurgical joints, to the expansion joint 38 (FIGS. 2-5). The lower flue 34 may be manufactured of 304 stainless steel or another material suitable for glass manufacturing equipment.

The circumferential shell 44 is internally cooled to help the lower flue 34 withstand the elevated temperatures associated with the melter 12, particularly the temperatures experienced near the exhaust outlet 32. For example, in this embodiment, the circumferential shell 44 includes two radially opposed walls that define an internal cooling passage 56 through which a coolant, such as air, water, and/or another gas or liquid, may be circulated. Preferably, the circumferential shell 44 of the lower flue 32 is cooled with water. The circumferential shell 44 may be configured to circulate the coolant through the internal cooling passage 56 of the shell 44 in any desirable way. For example, the circumferential shell 44 may include a coolant inlet proximate the lower radial flange 46 and in fluid communication with the internal cooling passage 56, a coolant outlet proximate the upper radial flange 48 and also in fluid communication with the internal cooling passage 56, and serpentine flow channels constituting all or part of the flow passage 56 that may be provided by a series of internal baffles extending between the walls of the circumferential shell 44. The circumferential shell 44 also optionally defines a condensate cleanout port 58 and a corresponding removable door 60 that covers the condensate cleanout port 58. The condensate cleanout port 58 is an opening that extends through the circumferential shell 44 to provide access to the exhaust flow passage 54 of the lower flue 32 for maintenance, cleaning, repair work, etc.

The lower flue 36 may additionally include one or more fluid spray nozzles 62, if desired, as shown in FIGS. 6 and 9. The one or more fluid spray nozzles 62 extend through the circumferential shell 44 and may be distributed at various locations around the shell 44. The fluid spray nozzle(s) 62 spray a cooling fluid into the exhaust flow passage 54 of the lower flue 34 to cool the exhaust material E as the exhaust material E flows upwards through the exhaust flow passage 54. The cooling fluid may be a gas, a liquid, an aerosol, or any other type of fluid, and in certain embodiments may include air and/or water. Spraying the cooling fluid directly into the exhaust material E within the exhaust flow passage 54, if practiced, cools the exhaust material E and supplements the cooling of the exhaust material E and the circumferential shell 44 that occurs by circulating the coolant through the internal cooling passage 56 within the circumferential shell 44. The internal cooling of the circumferential shell 44 and, if practiced, the additional cooling attributed to spraying the cooling fluid directly into the exhaust material E through the fluid spray nozzle(s) 62, helps minimize the adherence and accumulation of glass spatter that splashes onto the interior surface 52 from the glass melt M. This is because molten glass is less prone to stick to the interior surface 52 of the circumferential shell 44—thus making the molten glass spatter more likely to fall back into the tank 16 and recombine with the glass melt M—if the glass is cooled slightly from the temperature of the glass melt M. Moreover, if the cooling fluid sprayed through the fluid spray nozzle(s) 62 comprises a compressed gas, such as compressed air, the sprayed cooling fluid can dislodge and remove adhered glass and/or exhaust material condensate from the interior surface 52 of the circumferential shell 44, and may even help prevent such material accumulation in the first place.

Turning now to FIGS. 7 and 10, the upper flue 36 includes a circumferential shell 64, an upper radial flange 66, and a lower radial flange 68 that has an axially-extending peripheral lip 70 that projects upwardly towards the upper radial flange 66. The circumferential shell 64 has an interior surface 72 that defines an exhaust flow passage 74 of the upper flue 36. The circumferential shell 64 may be cylindrical in shape, and therefore circular in cross-section, although other configurations are certainly possible including those that provide the shell 64 with other cross-sectional shapes including, for example, ovular, octagonal, hexagonal, and rectangular. The upper radial flange 66 and the lower radial flange 68 each extend radially outwardly from the circumferential shell 64 and are spaced axially apart along, and are disposed proximate to opposed ends of, the circumferential shell 64. The upper radial flange 66 is connected, typically with fasteners (as shown) or metallurgical joints, to the hood 40 (FIG. 1), and the lower radial flange 68 is connected, again typically with fasteners (as shown) or metallurgical joints, to the expansion joint 38 (FIGS. 2-5). Similar to the lower flue 34, the upper flue 36 may be manufactured of 304 stainless steel or another material suitable for glass manufacturing equipment.

The circumferential shell 64 of the upper flue 36 is constructed similarly to the circumferential shell 44 of the lower flue 34. Specifically, in this embodiment, the circumferential shell 64 of the upper flue 36 is internally cooled to help the upper flue 36 withstand the elevated temperatures associated with the melter 12. Here, the circumferential shell 64 includes two radially opposed walls that define an internal cooling passage 76 through which a coolant, such as air, water, and/or another gas or liquid, may be circulated. The circumferential shell 64 of the upper flue 36 is preferably cooled with water and may be configured to circulate the water or other coolant through the internal cooling passage 76 of the shell 64 in any desirable way. For example, like the lower flue 34, the circumferential shell 64 of the upper flue 36 may include a coolant inlet proximate the lower radial flange 68 and in fluid communication with the internal cooling passage 76, a coolant outlet proximate the upper radial flange 66 and also in fluid communication with the internal cooling passage 76, and serpentine flow channels constituting all or part of the flow passage 76 that may be provided by a series of internal baffles extending between the walls of the circumferential shell 64. The circumferential shell 64 also optionally defines a condensate cleanout port 78 and a corresponding removable door 80 that covers the condensate cleanout port 78. The condensate cleanout port 80, like before, is an opening that extends through the circumferential shell 64 to provide access to the exhaust flow passage 74 of the upper flue 36.

The upper flue 36 may additionally include one or more of the fluid spray nozzles 82, if desired, as shown in FIGS. 7 and 10. Similar to the fluid spray nozzle(s) 62 of the lower flue 34, the one or more fluid spray nozzles 82 of the upper flue 36 extend through the circumferential shell 64 and may be distributed at various locations around the shell 64. The fluid spray nozzle(s) 82 spray a cooling fluid into the exhaust flow passage 74 of the upper flue 36 to cool the exhaust material E as the exhaust material E flows upwards through the exhaust flow passage 74. The cooling fluid may be a gas, a liquid, an aerosol, or any other type of fluid, and in certain embodiments may include air and/or water. Spraying cooling fluid directly into the exhaust material E within the exhaust flow passage 74, if practiced, cools the exhaust material E and supplements the cooling of the exhaust material E and the circumferential shell 64 that occurs by circulating the coolant through the internal cooling passage 76 within the circumferential shell 64 to help achieve the same result described above in connection with the lower flue 34—that is, to help minimize the adherence and accumulation of glass spatter that splashes onto the interior surface 72 from the glass melt M. Moreover, if the cooling fluid sprayed through the fluid spray nozzle(s) 82 comprises a compressed gas, such as compressed air, the sprayed cooling fluid can dislodge and remove adhered glass and/or exhaust material condensate from the interior surface 72 of the circumferential shell 64, and may even help prevent such material accumulation in the first place. The upper flue 36 may also include a camera 84 (FIG. 7), which is received in a camera port 86 that is defined in the circumferential shell 64 and provides the camera 84 with visual access to the exhaust flow passage 74.

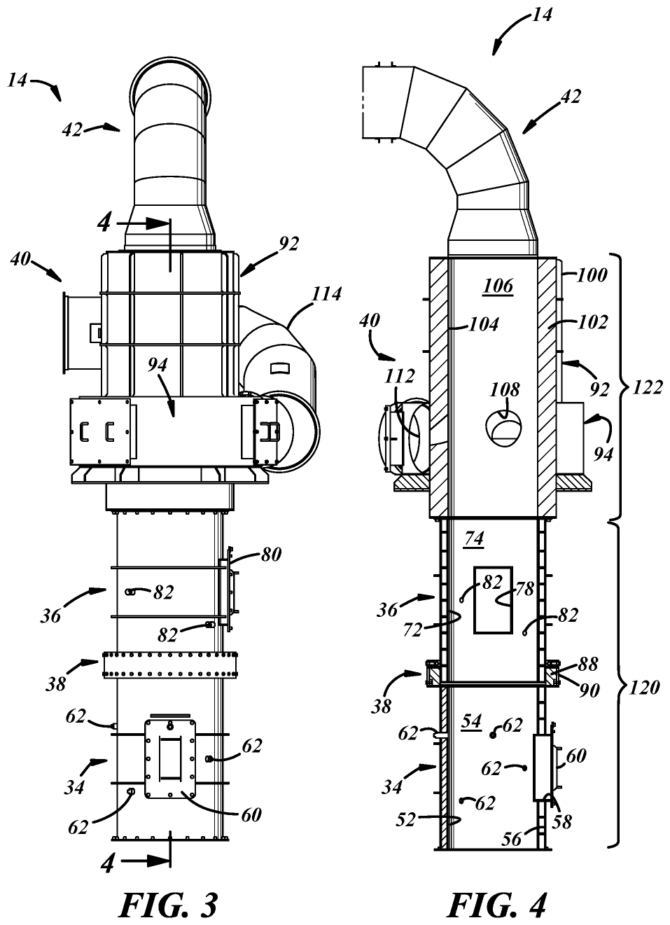

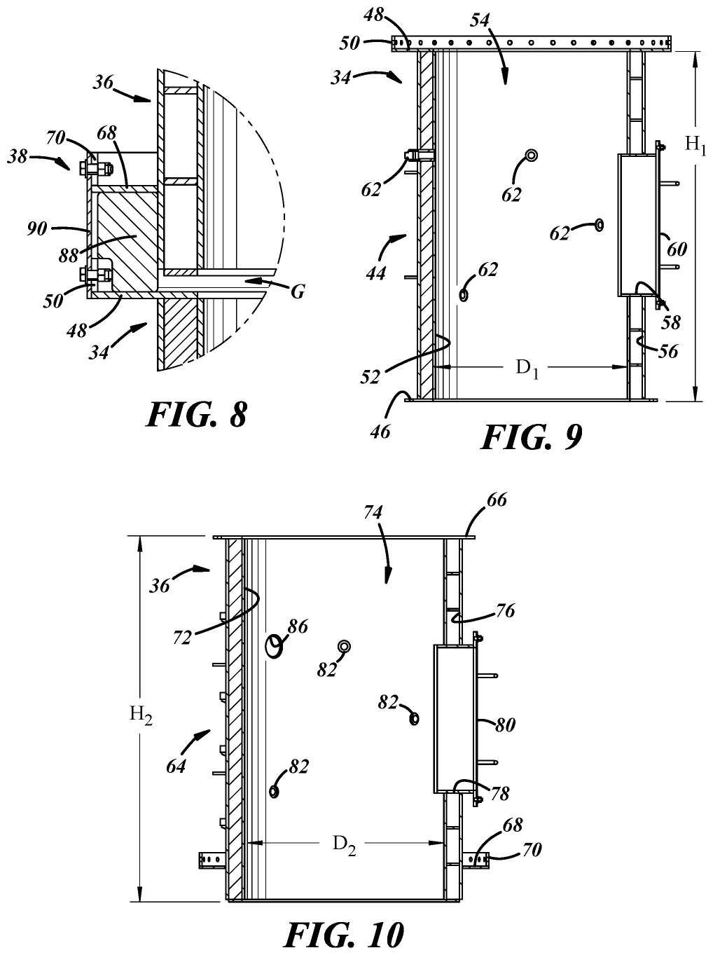

As shown best in FIGS. 3-5 and 8, the expansion joint 38 includes a thermal ring barrier 88 and a flexible protective cover 90 disposed radially outboard of the thermal ring barrier 88. The thermal ring barrier 88 is disposed axially between the upper radial flange 48 of the lower flue 34 and the lower radial flange 68 of the upper flue 36, while also being disposed radially between the flexible protective cover 90 and at least one of the circumferential shell 44 of the lower flue 36 or the circumferential shell 64 of the upper flue 36. As shown in FIG. 8, for example, the thermal ring barrier 88 is radially disposed between the flexible protective cover 90 and the circumferential shell 64 of the upper flue 36 beneath the lower radial flange 68 of the shell 64 (as shown), although the thermal ring barrier 88 may also be disposed radially between the flexible protective cover 90 and the circumferential shell 44 of the lower flue 44 above the upper radial flange 48 or the shell 44 or radially between the flexible protective cover 90 and both circumferential shells 44, 64. The thermal ring barrier 88 may be compressed axially by the radial flanges 48, 68, and it may be compressed radially by the flexible protective cover 90 and one or both of the circumferential shells 44, 64, but it does not necessarily have to be compressed in either direction since the thermal ring barrier 88 is typically non-weight bearing. The thermal ring barrier 88 may be a thermal insulation material that comprises, for example, fiber insulation, ceramic fiber insulation, wool insulation, or combinations thereof. In a preferred embodiment, the thermal ring barrier 88 comprises ceramic fibers encased within a ceramic fibrous pouch.

The flexible protective cover 90 is coupled to the upper radial flange 48 of the lower flue 34 and the lower radial flange 68 of the upper flue 36 and, in particular, to the peripheral lip 50 of the upper radial flange 48 of the lower flue 34 and the peripheral lip 70 of the lower radial flange 68 of the upper flue 36, preferably by fasteners. The flexible protective cover 90 conceals the thermal ring barrier 88 radially inwardly thereof and, additionally, each of the thermal ring barrier 88 and the flexible protective cover 90 surrounds and covers a junction between the circumferential shell 44 of the lower flue 34 and the circumferential shell 64 of the upper flue 36, which includes a gap G between the shells 44, 64. The gap G may be on the order of one inch or less to provide for relative movement between the shells 44, 64, as described below, while not being too excessive that molten glass may become trapped therein. In a preferred embodiment, the flexible protective cover 90 is comprised of a rubber material, a fabric material, a woven cloth, or a woven metallic material such as a woven stainless steel mesh. In addition to the gap G between the circumferential shell 44 of the lower flue 34 and the circumferential shell 64 of the upper flue 36, the flexibility and/or compliancy of the thermal ring barrier 88 and the flexible protective cover 90 permits the expansion joint 38 to absorb vibrations that propagate up through the lower flue 34 and to accommodate axial, lateral, and angular deflections that may occur between the lower and upper flues 34, 36 due to rocking and vibration of the melter 12, which may occur in submerged combustion melting since the glass melt M is in a constant state of agitation. Because the expansion joint 38 can accommodate such vibrations and deflections, some freedom of movement is permitted between the lower and upper flues 34, 36, and stresses that might otherwise damage a more rigid exhaust stack are mitigated or altogether avoided.

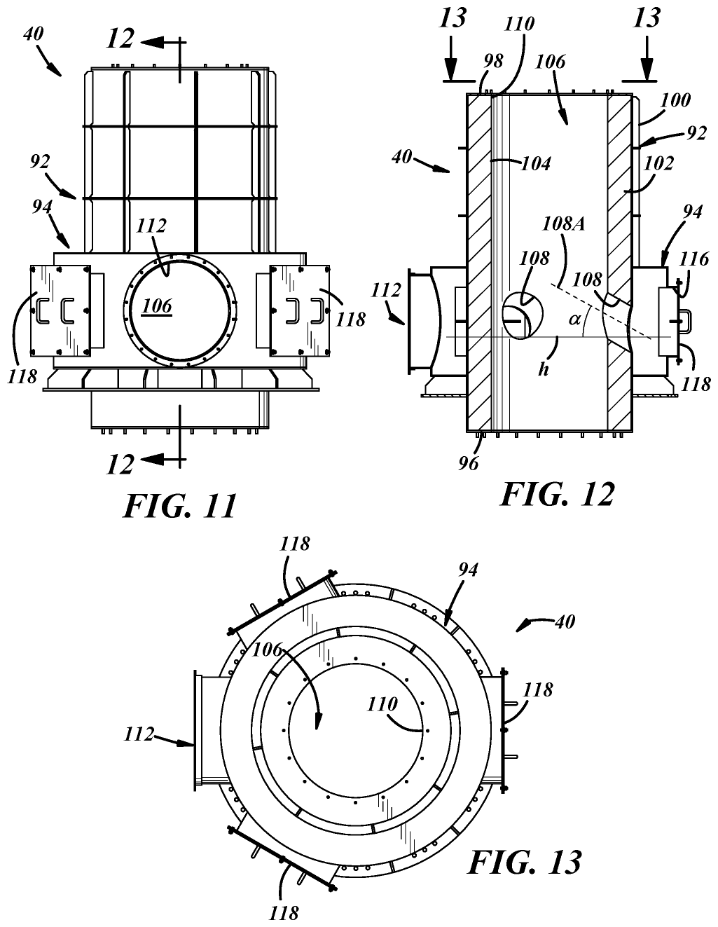

With reference now to FIGS. 11-13, the hood 40 includes a circumferential shell 92 and a dilution collar 94. The circumferential shell 92 has a lower mounting end 96 and an upper mounting end 98 (FIG. 12), each of which preferably includes fasteners mounted therein and protruding axially therefrom, although other options for mounting the hood 40 are certainly feasible. The circumferential shell 92 of the hood 40 includes an exterior wall 100 and an interior refractory liner 102. The exterior wall 100 is preferably constructed from a metal such as carbon steel or stainless steel. The interior refractory liner 102 has an interior surface 104 that defines an exhaust flow passage 106 of the hood 40 and is comprised of any suitable refractory material including, for example, fused cast AZS, bond AZS, castable AZS, high alumina, alumina-chrome, or and alumina-silica refractory such as Mullite. The interior refractory liner 102 is surrounded circumferentially by the exterior wall 100 and may or may not be covered by the exterior wall 100 at the mounting ends 96, 98. As for the mounting ends 96, 98 of the circumferential shell 92, the fasteners are embedded in the interior refractory liner 102. The lower mounting end 96 is coupled to the upper radial flange 66 of the upper flue 36 by receiving the embedded fasteners through the upper radial flange 66 and securing them in place with corresponding nuts. The upper mounting end 98 is similarly coupled to the exhaust outlet conduit 42, preferably with fasteners. The exhaust outlet 42 directs the exhaust material E away from the hood 40 and guides the exhaust material E further downstream as discussed above.

The circumferential shell 92 of the hood 40 defines one or more dilution inlets 108 and a hood outlet 110. Each of the dilution inlets 108 extends through the circumferential shell 92 to the exhaust flow passage 106 and has a central axis 108A. The central axis 108A of each dilution inlet 108 may be parallel to a horizontal reference line h (i.e., a line extending perpendicular to gravity) or it may be upwardly inclined so as to form an angle α with respect to the horizontal reference line h that ranges from 5° to 85° or, more narrowly, from 15° to 75°, as shown in FIG. 12. The dilution inlet(s) 108 are used to supply a diluent such as air, for example, into the exhaust flow passage 106 of the hood 40 for direct mixing with the exhaust material E, and may include a series of such inlets 108 spaced circumferentially around the shell 92. The inlet(s) 108 may be upwardly angled relative to the horizontal reference line h to direct the diluent into the exhaust material E along an upward vector to help maintain a minimum velocity and pressure of the exhaust material E as the exhaust material E flows through the hood 40. In so doing, dead flow zones—or regions of low pressure and/or low flow velocity—within the hood 40 can be minimized or prevented, which, in turn, decreases the likelihood that condensate from the exhaust material E will accumulate on the interior surface 104 of the circumferential shell 92 of the hood 40. Dilution inlets 108 that are parallel to the horizontal reference line h can also achieve the same results, particularly if many inlets 108 are disposed around the circumferential shell 92 to create a well distributed pressure and velocity of diluent flow. The hood outlet 110 is the opening through which the exhaust material E flows out of and exits the hood 40 and then enters the exhaust conduit 42. The hood outlet 110 is typically defined by or proximate to the upper mounting end 98 of the shell 92, as shown here, with the longitudinal axis L_{A} preferably extending centrally through the hood outlet 110.

The dilution collar 94 circumscribes the circumferential shell 92 of the hood 40 and covers the dilution inlet(s) 108. The dilution collar 94 receives the diluent through a diluent intake opening 112 and distributes the diluent, preferably air, circumferentially around the circumferential shell 92 within a flow distribution passage defined by the collar 94 to supply the diluent into the exhaust flow passage 106 of the hood 40 through the diluent inlet(s) 108. The diluent may be supplied to the dilution collar 94 in any suitable manner including, for example, through a diluent supply duct 114 that fluidly communicates with a source of the diluent and is coupled to the dilution collar 94 over the diluent intake opening 112. The dilution collar 94 may include at least one condensate cleanout port 116 and a corresponding removable door 118 that covers the cleanout port 116 to allow access to the interior of the collar 94. As best shown in FIG. 12, each of the dilution inlet(s) 108 preferably has one of the condensate clean out port(s) 116 positioned radially opposite to the inlet 108 so that the dilution inlet(s) 108 can be easily accessed via the condensate cleanout port(s) 116 for cleaning, maintenance, or some other reason.

The operation of the exhaust stack 14 involves receiving the exhaust material E in the stack 14 from the SC melter 12. When the melter 12 is being used to make glass, the submerged combustion burners 18 discharge combustion products, which are produced by combusting a mixture of the fuel and the oxidant, directly into the glass melt M contained within the tank 16. The discharged combustion products heat and agitate the glass melt M, and the batch feed material that is introduced into the tank 16 is melted, within the agitated glass melt M, into glass. When the submerged combustion burners 18 are fired and running, the exhaust material E is generated within the interior 20 of the tank 16. The exhaust material E is directed through the exhaust outlet 32 and into the exhaust stack 14. And, once in the exhaust stack 14, the exhaust material E flows through the exhaust stack 14 and is cooled while being guided away from the melter 12. Indeed, the exhaust flow passage 54 of lower flue 34, the exhaust flow passage 74 of upper flue 36, and the exhaust flow passage 106 of hood 40 are serially arranged to provide a single, continuous exhaust flow passage for contained flow of the exhaust material E through the stack 14 from the exhaust outlet 32 of tank 16 to the hood outlet 110 of hood 40 and, eventually, into the exhaust outlet conduit 42.

The cooling of the exhaust material E may occur in two stages of the exhaust stack 14: a first stage 120 and a second stage 122 (FIGS. 2 and 4). The first stage 120 of the exhaust stack 14 includes the lower flue 34, the expansion joint 38, and the upper flue 36, and the second stage 122 includes the hood 40. In the first stage 120, each of the lower flue 34 and the upper flue 36 may be internally cooled by their respective coolants, which, as described above, circulate through the circumferential shell 44 of the lower flue 34 and the circumferential shell 64 of the upper flue 36. Additionally, in each of the lower flue 34 and the upper flue 36, the cooling fluid may be sprayed directly into the exhaust material E through the fluid spray nozzle(s) 62, 82 as the exhaust material E flows upwards through the exhaust flow passage 54, 74 of the flue 34, 36. Both forms of cooling—that is, internally cooling of the circumferential shell 44, 64 and spraying the cooling fluid into the exhaust flow passage 54, 74—may be practiced in each of the lower flue 34 and the upper flue 36, although only one of the two forms of cooling may need to be practiced in one or both of the flues 34, 36 to achieve satisfactory cooling. In the second stage 122, within the hood 40, the diluent is introduced into the exhaust flow passage 106 of the hood 40 through the diluent inlet(s) 108 and mixed directly into the exhaust material E, which further cools the exhaust material E from that which occurred in the first stage 120. In one implementation, the cooling fluid that is sprayed directly into the exhaust material E in the lower and/or upper flues 34, 36, if employed, and the diluent that is mixed directly into the exhaust material E in the hood 40 are different. For example, the sprayed cooling fluid may comprise water (liquid and/or vapor), and optionally a compressed gas to provide a high pressure water spray, and the diluent may comprise air.

The cooling that occurs in the first stage 120, whether through internal cooling and/or directly spraying the cooling fluid into the exhaust material E in one or both of the lower and upper flues 34, 36, cools the exhaust material M and also cools any molten glass spatter that that may have splashed onto the interior surface 52 of the circumferential shell 44 of the lower flue 34 and/or the interior surface 72 of the circumferential shell 64 of the upper flue 36. The cooling of the any glass spatter that splashes up into the lower flue 34 and the upper flue 36 renders such glass less sticky and, as a result, makes it more likely that the glass will slide down the interior surfaces 52, 72 of the circumferential shells 44, 64 and drop back into the tank 16 through the exhaust outlet 32 and recombine with the glass melt M. The cooling of the exhaust material E itself is also beneficial since the material E, when it exits the tank 16, is generally too hot for downstream treatment, abatement, recycling, release, etc. The cooling of the exhaust material E that occurs within the first stage 120 happens close to the tank 16, when the exhaust material E is hottest, and can therefore efficiently extract heat from the exhaust material E to help reduce the cooling demand placed on the second stage 122. Furthermore, if the cooling fluid is sprayed through the fluid spray nozzle(s) 62, 82 of one or both the lower and upper flues 34, 36, the sprayed cooling fluid can sweep along the interior surface 52, 72 of the circumferential shell 44, 64 of their respective flue 34, 36 and push any molten glass spatter and/or exhaust material condensate away from the interior surface 52, 72 and even help dislodge any such materials that have built up on the interior surface 52, 72.

The cooling that occurs in the second stage 122 by introducing the diluent directly into the exhaust material E within the hood 40 further cools the exhaust material E as needed for downstream unit operations. And, because the diluent is preferably introduced directly into the exhaust material E at an upward angle α from the horizontal reference line h—meaning the diluent is angled into (rather than against) the flow direction of the exhaust material E through the hood 40—dead flow zones are minimized within the hood 40, although a similar effect can be achieved without such an upward flow angle if a sufficient number of diluent inlets 108 are distributed around the circumferential shell 92 of the hood 40. By minimizing dead flow zones, any condensate that condenses out of the exhaust material E when the diluent is mixed into the exhaust material E will be more prone to be swept up and captured by the exhaust material E and carried out of the hood 40 and into the exhaust outlet conduit 42, as opposed to settling and accumulating within the hood 40 or falling back down into the flues 34, 36 or even the into the tank 16. Unlike the lower and upper flues 34, 36, the hood 40 is refractory lined with the interior refractory liner 102 and is not internally cooled with a circulating coolant. The refractory liner 102 allows the hood 40 to withstand the temperatures associated with the exhaust material E in the absence of internal cooling.

The combined cooling provided by the first and second stages 120, 122 of the exhaust stack 14 attempts to cool the exhaust material E that exits the tank 16 of the melter 12 while addressing the challenges posed by a turbulent glass melt M that can splash molten glass out of the exhaust outlet 32 as well as the handling of exhaust material condensate that may condense out of the exhaust material E after the exhaust material E exits the tank 16. When the SC melter 12 is making soda-lime-silica glass, the exhaust material may have a temperature between 1250° C. and 1350° C. at the exhaust outlet 32. A coolant may be internally circulated through each of the lower flue 34 and the upper flue 36 and may enter the internal cooling passage 56, 76 of its respective flue 34, 36 at a temperature between 0° C. and 40° C. or, more narrowly, between 10° C. and 30° C. At the same time, the optional fluid spray nozzle(s) 62, 82 of each of the lower flue 34 and the upper flue 36 may spray a cooling fluid directly into the exhaust material E at a temperature between 0° C. and 70° C. or, more narrowly, between 10° C. and 30° C. And, to help ensure that all of the molten glass spatter splashed into the exhaust stack 14 remains confined to the lower flue 34 and the upper flue 36, the exhaust flow passage 54 of the lower flue 34 and the exhaust flow passage 74 of the upper flue 36 each have a diameter D1, D2 and a height H1, H2 (FIGS. 9-10), respectively, with a preferred height to diameter ratio H1:D1, H2:D2 of 2.5 or greater. As the exhaust material E flows through the hood 40, the diluent is mixed directly into the exhaust material E at a temperature that between 0° C. and 40° C. or, more narrowly, between 10° C. and 30° C., and the temperature of the exhaust material is decreased to between 500° C. and 700° C. at the hood outlet 110. Each of the lower flue 34, the upper flue 36, and the hood 40 are preferably coaxially aligned along the longitudinal axis L_{A} to assist with flow dynamics and to avoid turns and bends where exhaust material condensate can be trapped

The subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. As such, many other embodiments, modifications, and equivalents thereto, either exist now or are yet to be discovered and, thus, it is neither intended nor possible to presently describe all such subject matter, which will readily be suggested to persons of ordinary skill in the art in view of the present disclosure. Rather, the present disclosure is intended to embrace all such embodiments and modifications of the subject matter of this application, and equivalents thereto, as fall within the broad scope of the accompanying claims.

1. A submerged combustion melting system, comprising:
a submerged combustion melter that includes a tank, which defines an exhaust outlet, and one or more submerged combustion burners mounted to the tank; and
an exhaust stack connected to the tank of the melter, the exhaust stack comprising:
a lower flue coupled to the tank and extending upwardly away from the tank, the lower flue comprising a circumferential shell that defines an exhaust flow passage and fluidly communicating with the exhaust outlet of the tank;
an upper flue extending upwardly away from the lower flue, the upper flue comprising a circumferential shell that defines an exhaust flow passage and fluidly communicating with the lower flue;
an expansion joint disposed between the lower flue and the upper flue and which compliantly couples the lower flue and the upper flue together; and
a hood coupled to the upper flue and extending upwardly away from the upper flue, the hood fluidly communicating with the upper flue and comprising a circumferential shell that defines an exhaust flow passage and has an interior refractory liner, and wherein the circumferential shell of the hood defines one or more dilution inlets and a hood outlet.

2. The submerged combustion melting system set forth in claim 1, wherein the circumferential shell of the lower flue defines an internal cooling passage configured to circulate a coolant therethrough, and wherein the circumferential shell of the upper flue defines an internal cooling passage configured to circulate a coolant therethrough.

3. The submerged combustion melting system set forth in claim 1, wherein the lower flue further comprises one or more fluid spray nozzles that extend through the circumferential shell of the lower flue to spray a cooling fluid into the exhaust flow passage of the lower flue, and wherein the upper flue further comprises one or more fluid spray nozzles that extend through the circumferential shell of the upper flue to spray a cooling fluid into the exhaust flow passage of the upper flue.

4. The submerged combustion melting system set forth in claim 1, wherein the expansion joint includes a thermal ring barrier and a flexible protective cover that conceals the thermal ring barrier radially inwardly thereof, the flexible protective cover surrounding and covering a junction between the circumferential shell of the lower flue and the circumferential shell of the upper flue.

5. The submerged combustion melting system set forth in claim 1, wherein each of the one or more dilution inlets extends through the circumferential shell of the hood to the exhaust flow passage of the hood and has a central axis that is upwardly inclined so as to form an angle with respect to a horizontal reference line.

6. The submerged combustion melting system set forth in claim 1, wherein the circumferential shell of the hood defines a plurality of the dilution inlets, and wherein the hood further comprises a dilution collar that circumscribes the circumferential shell of the hood and covers the dilution inlets, the dilution collar defining a diluent intake opening to receive a diluent for distribution circumferentially around the circumferential shell of the hood within the diluent collar and through the plurality of dilution inlets.

7. The submerged combustion melting system set forth in claim 1, wherein the exhaust stack further includes an exhaust outlet conduit that is coupled to and fluidly communicates with the hood.

8. The submerged combustion melting system set forth in claim 1, wherein each of the lower flue, the upper flue, and the hood extends upwardly along a longitudinal axis that extends centrally through the exhaust outlet of the tank.

9. An exhaust stack for a submerged combustion melter, the exhaust stack comprising:
a lower flue that includes a circumferential shell having an interior surface that defines an exhaust flow passage of the lower flue, the circumferential shell of the lower flue also defining an internal cooling passage configured to circulate a coolant through the circumferential shell of the lower flue;
an upper flue that includes a circumferential shell having an interior surface that defines and exhaust flow passage of the upper flue, the circumferential shell of the upper flue also defining an internal cooling passage configured to circulate a coolant through the circumferential shell of the upper flue;
an expansion joint disposed between the lower flue and the upper flue and which compliantly couples the lower flue and the upper flue together;
a hood coupled to the upper flue and that includes a circumferential shell, the circumferential shell of the hood having an interior refractory liner that defines an exhaust flow passage of the hood, wherein the circumferential shell of the hood defines one or more dilution inlets, and wherein each of the one or more dilution inlets extends through the circumferential shell of the hood to the exhaust flow passage of the hood.

10. The exhaust stack set forth in claim 9, wherein the expansion joint includes a thermal ring barrier and a flexible protective cover that conceals the thermal ring barrier, the flexible protective cover surrounding and covering a junction between the circumferential shell of the lower flue and the circumferential shell of the upper flue.

11. The exhaust stack set forth in claim 10, wherein the lower flue includes an upper radial flange extending from the circumferential shell of the lower flue, wherein the upper flue includes a lower radial flange extending from the circumferential shell of the upper flue, and wherein the thermal ring barrier is disposed axially between the upper radial flange of the lower flue and the lower radial flange of the upper flue as well as radially inwardly of the flexible protective cover.

12. The exhaust stack set forth in claim 9, wherein each of the one or more dilution inlets has a central axis that is upwardly inclined so as to form an angle with respect to a horizontal reference line.

13. The exhaust stack set forth in claim 9, wherein the circumferential shell of the hood defines a plurality of the diluent inlets, and wherein the hood further comprises a dilution collar that circumscribes the circumferential shell of the hood and covers the dilution inlets, the dilution collar defining a diluent intake opening to receive a diluent for distribution circumferentially around the circumferential shell of the hood within the diluent collar and through the plurality of diluent inlets.

14. The exhaust stack set forth in claim 13, wherein at least one of the lower flue or the upper flue further comprises one or more fluid spray nozzles configured to spray a cooling fluid into its respective exhaust flow passage.

15. A method of cooling an exhaust material exiting a submerged combustion melter, the method comprising:
discharging combustion products from one or more submerged combustion burners directly into a glass melt contained within an interior of a tank of a submerged combustion melter to heat and agitate the glass melt;
directing an exhaust material generated within the interior of the tank through an exhaust outlet of the tank and flowing the exhaust material through an exhaust stack that is connected to the tank of the submerged combustion melter, the exhaust stack comprising a lower flue coupled to the tank and in fluid communication with the exhaust outlet, an upper flue in fluid communication with the lower flue, and a hood in fluid communication with the upper flue;
cooling the exhaust material in the lower flue with a coolant that circulates within an internal cooling passage of the lower flue and/or by spraying a cooling fluid directly into the exhaust material as the exhaust material flows through the lower flue;
cooling the exhaust material in the upper flue with a coolant that circulates within an internal cooling passage of the upper flue and/or by spraying a cooling fluid directly into the exhaust material as the exhaust material flows through the upper flue;
cooling the exhaust material in the hood by directly mixing a diluent into the exhaust material as the exhaust material flows through the hood; and
flowing the exhaust material out of the hood, through a hood outlet, and downstream of the exhaust stack.

16. The method set forth in claim 15, wherein cooling the exhaust material in the lower flue comprises circulating the coolant through the internal cooling passage defined in the circumferential shell of the lower flue, and wherein cooling the exhaust material in the upper flue comprises circulating the coolant through the internal cooling passage defined in the circumferential shell of the upper flue.

17. The method set forth in claim 15, wherein the diluent is comprised of air.

18. The method set forth in claim 15, wherein cooling the exhaust material in the hood by directly mixing the diluent into the exhaust material comprises introducing the diluent directly into the exhaust material at an upward angle relative to a horizontal reference line.

19. The method set forth in claim 15, wherein the lower flue and the upper flue are compliantly coupled together.

20. The method set forth in claim 15, wherein the exhaust material has a temperature between 1250° C. and 1350° C. at the exhaust outlet of the tank of the submerged combustion melter, and wherein the exhaust material has a temperature between 500° C. and 700° C. at the hood outlet.
